(19) United States
(12) Patent Application Publication
(10) Pub. No.: US 2003/0046670 A1
(43) Pub. Date: Mar. 6, 2003

(54) Binary object system for automated data translation

(76) Inventor: Mark J. Marlow, Boxboro, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/882,874

(22) Filed: Jun. 15, 2001

(51) Int. Cl. G06F 9/45

(52) U.S. Cl. 717/140

(57) ABSTRACT

Apparatus for the automated translation of data sets includes a computer at a local site receiving information from a remote site. The computer compiles this information into one or more binary objects, and uses these binary objects to service customer requests by transforming a data value from a first representation into a second representation. The received information is typically localization information, e.g., rules for time zone conversion, daylight savings time adjustments, currency conversion, language translation, etc., but can address other types of conversion. A system formed by the remote site, the computer at the local site with a binary object in memory, and a communications module connecting the two, and a method are also discussed.

### FIELD OF THE INVENTION

The present invention relates to methods and apparatus to implement automated translation of data sets between representations. In particular, the present invention relates to binary objects generated using remotely-sited data sets.

### BACKGROUND OF THE INVENTION

Referring to FIG. 1, a prior art networked computer configuration includes a first computer 100, a second computer 102, and a telecommunications link 104. Computers 100 and 102 are standalone personal computers, a client computer and a server computer, mainframe computers, distributed computing clusters, portable computers, handheld computing devices, or any other general purpose or special purpose computing device.

Telecommunications link 104 interconnects first computer 100 and second computer 102. Interconnection permits the exchange of data and other messages between first computer 100 and second computer 102. Telecommunications link 104 is a fiber-optic link, a radio-frequency link, a microwave link, a telephone line, a high-speed dedicated data line, or any other telecommunications link. The data may be exchanged using a variety of communications protocols such as HTTP, TCP/IP, IPX, SPX, NetBIOS, Ethernet, RS-232, and direct asynchronous connections.

Data entries exchanged by computers 100 and 102 are necessarily characterized by the units used to represent the information in the data entries. For example, financial information is necessarily characterized by currency units (e.g., dollar, marks, pounds, etc.). Similarly, a set of characters is necessarily characterized by its encoding scheme. A character set transmitted in EBCDIC format (i.e., Extended Binary-Coded Decimal Interchange Code) will not be received correctly if the receiver expects a character set in ASCII format (i.e., American Standard Code for Information Interchange).

This problem is analagous to particular problems requiring data localization. Typically computers 100 and 102 are separated by a significant distance. Thus, first computer 100 operates in a first geographic region 106 and second computer 102 operates in a second geographic region 108. Geographic regions 106 and 108 are potentially located in different sociopolitical entities. For example, in one embodiment computer 100 operates in Yuma, Ariz., United States of America, computer 102 operates in Oslo, Norway, and a fiber-optic telecommunications link 104 connects computers 100 and 102.

Geographic regions 106 and 108 typically differ in one or more ways. Potential idiosyncrasies include different currency units, different representations of the same moment in time, and different languages for verbal and written communications. These idiosyncrasies are conveniently characterized as “localized values,” because they are local to particular sociopolitical entities or geographic regions. Consequently, sets of data from geographic region 106 including one or more localized values require translation or intermediation before they can be effectively utilized by an individual in geographic region 108. For example, records stored on computer 100 using United States dollars (USD) and Eastern Standard Time (EST) may require conversion to Pacific Standard Time (PST) and pesos when computer 102 located in Tijuana, Mexico accesses the records.

Similarly, rules specifying a mapping between two localized values or sets of values are conveniently characterized as “localization information” because they can be used to convert a data set from a first sociopolitical entity or geographic region to conform with the idiosyncrasies of a second sociopolitical entity or geographic region.

For clarity, the preceding discussion was limited to two computers in two geographic regions. However, a typical network configuration can easily encompass computers in tens or hundreds of geographical regions or sociopolitical entities. For typical network configurations the problem of computer-to-computer translation is combinatorically difficult. For example, assuming that dates and times are the only values to be localized, there are approximately 300 rules for transforming time values to a neutral intermediary format, such as coordinated universal time (UTC), to the local time in various sociopolitical entities. Therefore, a two-step conversion between a first localized time value and a second localized time value potentially requires a set of approximately 90,000 rules (i.e., 300 squared) simply to address the issue of time localization. The problem is further compounded by the presence of other localized values for conversion, such as currencies or languages, and data sets potentially having millions of individual entries. Thus, the translation of data sets is required in an endless number of scenarios: converting number sets between different bases, converting values in an image file to accommodate particular monitor characteristics, converting alphanumeric characters between representations (e.g., EBCDIC to ASCII), converting quantized data values between different quantization schemes, etc.

Of course, it is possible to load all the provided conversion information into an array in random-access memory (RAM). The system could then identify particular subsets of conversion information as necessary. However, loading the entire set of conversion information, potentially tens of thousands of entries in size, could unacceptably slow other ongoing transactions. Second, loading the conversion information assumes that this information is always up-to-date and accessible to the loading computer. If the information is on-hand but out-of-date, it is not only useless but potentially harmful, yielding incorrect results. If the information is periodically updated at a remote site, then the local computer will rely on the proper operation of the remote computer and the intervening network. If either of these assumptions are incorrect, then the system will lack the information to operate properly. Third, the array will use sizeable amounts of (RAM) for mere storage, when the memory would be better used to speed the processing of user-oriented transactions.

Therefore, there is a need for a fast, automated, and self-maintaining system for translating data sets between multiple representations.

### SUMMARY OF THE INVENTION

The present invention avoids these problems by building a large set of individually small binary objects. First, the objects are built off-line, thereby minimizing any drain of system resources needed to process live user transactions. Second, the objects are built and then stored locally, so that remote computer or network failures at least do not inhibit the conversion process described above. Third, the binary objects use small amounts of RAM and can be quickly loaded and unloaded, minimizing their drain on system resources best used to process live user transactions.

In one aspect, the present invention relates to a method for generating a binary object in a computer system including a local site in communications with a remote site. In one embodiment, the local site receives information from a remote site, compiles the information into a binary object, and uses the binary object to service a customer request. In another embodiment, the local site stores the binary object.

In still another embodiment, the binary object includes a method for converting a coordinated universal time (UTC) value to a localized time value. In one embodiment, the method for converting a coordinated universal time (UTC) value to a localized time value includes the steps of receiving a coordinated universal time (UTC) value, converting the UTC value to a localized time value, and providing the localized time value.

In another embodiment, the binary object includes a method for converting a localized time value to a coordinated universal time (UTC) value. In one embodiment, the method for converting a localized time value to a coordinated universal time (UTC) value includes the steps of receiving a localized time value, converting the localized time value to a UTC value, and providing the UTC value.

In still another embodiment, the step of compiling information into a binary object includes the steps of converting the information into a source code file and compiling the source code file into a binary object.

In another aspect, the present invention relates to a method for generating a binary object in a computer system including a local site in communication with a remote site. First, a local site receives from a remote site information including localization information. This localization information is subsequently compiled into a binary object. In one embodiment, the localization information includes information describing a relationship between coordinated universal time (UTC) and localized time or information describing scheduled clock adjustments, such as daylight savings time.

In another embodiment, the binary object includes a method for converting a coordinated universal time (UTC) value into a localized time value. In one embodiment, this method includes the steps of receiving a coordinated universal time (UTC) value, converting the UTC value to a localized time value, and providing the localized time value.

In yet another embodiment, the binary object includes a method for converting a localized time value into a coordinated universal time (UTC) value. In one embodiment, this method includes the steps of receiving a localized time value, converting the localized time value to a coordinated universal time (UTC) value, and providing the coordinated universal time (UTC) value.

In another embodiment, the method for generating a binary object in a computer system further includes the step of applying the compiled binary object to information received through a connection between the local site and a remote site which is not necessarily the remote site providing the information including localization information. In still another embodiment, this received information includes a localized time value.

In another embodiment, the step of compiling localization information into a binary object includes the steps of converting the localization information into a source code file and compiling the source code file into a binary object. In one embodiment, the source code file is a Visual Basic file. In yet another embodiment, the binary object is a common-object model (COM) dynamically-linked library (DLL).

In another aspect, the present invention is a system for providing automated localization of data sets including a remote site and a local site. The local site includes a computer with a binary object including a method for time conversion, and a communications module providing telecommunications between the remote site and the local site. Using the communications module, the remote site provides to the local site a record including a data entry including a time value.

In another aspect, the present invention is a method for facilitating automated localization of data sets in a computer system including a local site and a remote site. First, a connection is provided between the local site and the remote site. Information including a first time value is received at the local site from the remote site. A transformation applied to the received information converts the first time value into a second time value, which is subsequently provided.

### BRIEF DESCRIPTION OF THE DRAWINGS

These and other advantages of the invention may be more clearly understood with reference to the specification and the drawings, in which:

FIG. 1 is a diagram of a prior art networked computer configuration;

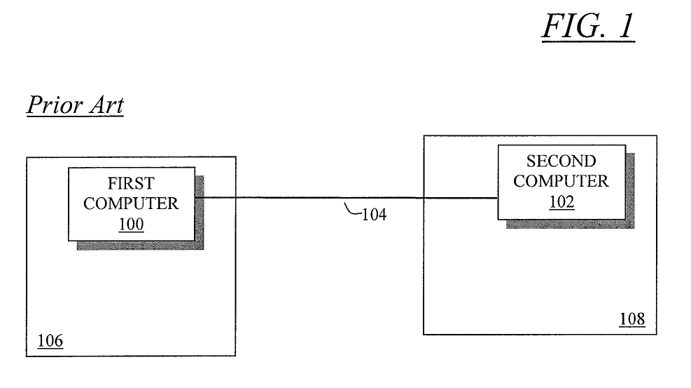

FIG. 2 is a diagram of a networked computer configuration in accordance with an embodiment of the present invention; and

FIG. 3 is a flowchart of a method for generating binary objects in accord with an embodiment of the present invention.

In the drawings, like reference characters generally refer to the same parts throughout the different views. The drawings are not necessarily to scale, emphasis instead being placed upon illustrating the principles of the invention.

### DETAILED DESCRIPTION OF THE INVENTION

In brief overview, embodiments of Applicant's invention provides methods and apparatus for the automated translation of data sets. A computer at a local site receives information from a remote site. The received information is typically localization information, e.g., rules for time zone conversion, daylight savings time adjustments, currency conversion, language translation, etc., but can address other types of conversions. The computer at the local site compiles this information into one or more binary objects, and uses these binary objects to service customer requests, transforming a data value between a first representation and a second representation. Embodiments of the present invention also encompass a system formed by the remote site, the computer at the local site with a binary object in memory, and a communications module connecting the two.

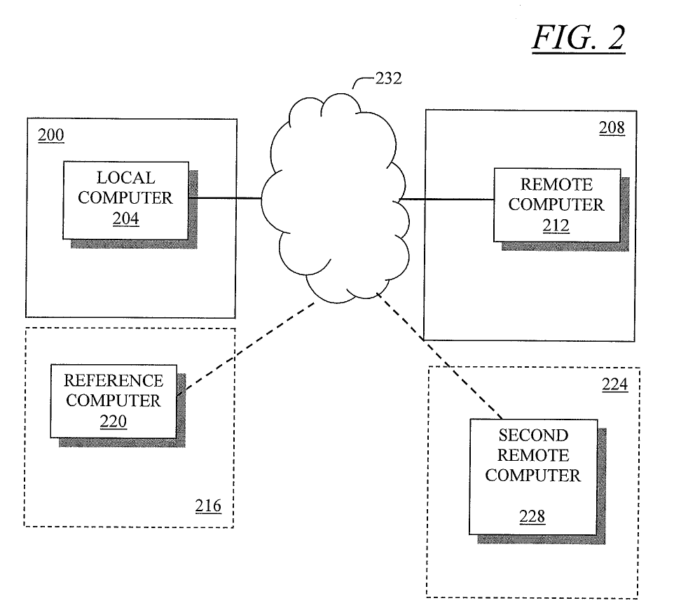

FIG. 2 depicts a computer system in accord with the present invention. Each site in the system includes a computer. Local site 200 hosts at least one local computer 204. Remote site 208 hosts at least one remote computer 212. (Remote site 208 need not be geographically remote. “Remote” merely connotes a location other than local site 200.) When present, reference site 216 hosts at least one reference computer 220 and second remote site 224 hosts at least one second remote computer 228. In some embodiments the remote site 208 provides the functionality of reference site 216. Computers 204, 212, 220, and 228 are standalone personal computers, a client computer and a server computer connected by a local subnetwork, mainframe computers, distributed computing clusters, portable computers, handheld computing devices, or any other general purpose or special purpose computing device.

The sites are connected by telecommunications network 232, permitting the exchange of data among computers 204, 212, 220, and 228. Telecommunications network 232 includes standard telephone lines, LAN or WAN links (e.g., T1, T3, 56 kb, X.25), broadband connections (e.g., ISDN, Frame Relay, ATM), and wireless connections (e.g., a radio-frequency link, a laser link, a microwave link). Each site includes a communications module or equivalent thereof that provides telecommunications between its hosted sites and other sites on the telecommunications network.

The remote computer 212 provides at least one record to local computer 204 using telecommunications network 232. The record itself includes one or more data entries that include but are not limited to at least one of a time, a date, a monetary value, a character, a pixel value, or a word or phrase in a particular language. The record is transmitted through telecommunications network 232.

In accord with the present invention, local computer 204 includes at least one binary object. The binary object includes at least one method for data translation. This includes but is not limited to methods for the conversion of time values between time zones, time adjustments required by local daylight savings time policies, currency conversions, conversions between character encoding formats, conversions between pixel or colormap values, and language translation. Upon receipt of the information provided by remote computer 212 at local computer 204, the information is either stored for subsequent processing or immediately processed. Processing requires the use of one or more binary objects to service one or more data entries. For example, processing can use a first binary object to convert a data entry from a localized format to an intermediate format, and then use a second binary object to transform the intermediate format to a second localized format differing from the original localized format. Processing could involve one binary object that included both these methods, or a single binary object that delocalized and relocalized the data without converting it to an intermediary format.

These binary objects are derived from information provided by reference computer 220 to local computer 204 through telecommunications network 232. Local computer 204 converts the information, a subset thereof, or an entry therein into a source code file. Local computer 204 compiles the source code file to form a binary object. Local computer 204 typically repeats the generation process to form multiple binary objects. A first type of binary object called a conversion object typically includes at least one method for transforming a data entry between values. A second type of binary object referred to as a listing object typically includes at least one method for providing a list of areas or zones.

For example, in one embodiment, local computer 204 is a centralized data warehouse used by at least one remote computer 212. Remote computer 212 periodically, intermittently, or on an as-needed basis transmits data sets for backup, short-term storage, or long-term storage at local computer 204. These data sets include but are not limited to financial information, text, time information, pixel values, or characters.

In this embodiment, a user wishes to view one or more data entries previously transmitted to local computer 204. The user operates computer 228 in a second remote location 224. Second remote location 224 differs from remote location 208 in terms of its preferred language, its local time, its preferred currency, etc. Thus, the user viewing the data entries must translate them to address the idiosyncrasies of remote location 224 before the data can be fully utilized.

The present invention automates the translation process in this embodiment by applying precompiled binary objects to the data entries, transforming them to values appropriate for viewing by the user at second remote location 224. Thus, when the user sends a request for data entries including, for example, financial information, the local computer 204 receives the request, locates the requested data entries, selects an appropriate binary object, and uses the selected binary object to transform the financial information from the currency of local site 200 to the currency of the second remote location 224. In some embodiments, the user's preferred currency is determined using his location information, which is retrieved using methods described below. In other versions, the user's preferred currency is stored on computer 204, 212, 220 or 228 as a data file, “cookie” or other file means.

In some embodiments, the system administrator directly provides his location information to local computer 204. In still other versions, local computer 204 polls the computer used by the system administrator for location information, or indirectly determines its location through a reverse DNS lookup or a reverse telephone lookup. The local computer 204 uses this location information to determine which compiled binary object is required for data transformation or localization. The system administrator may also provide data selection criteria to local computer 204, such as a range of dates, a range of times, or a range of error codes. In response, local computer 204 only provides data pre-translation or post-translation complying with these specified criteria.

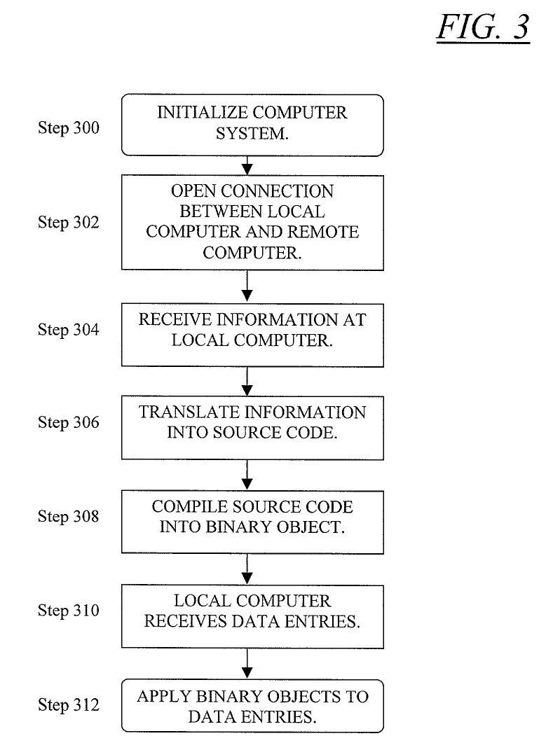

FIG. 3 illustrates a method for generating binary objects in a computer system in accord with the present invention. After the computer system is initialized (Step 300), a connection is initiated between a local computer 204 and a remote computer 212 (Step 302). The identity of the other computer, e.g., its IP address or domain name, is predetermined or dynamically-generated by querying a search engine or other information service. In some embodiments, the local computer 204 initiates the connection. In other embodiments, the remote computer 212 initiates the connection.

Stored information on the remote computer 212 is transferred to local computer 204. In some embodiments, local computer 204 initiates the transfer. In other embodiments, the remote computer 212 initiates the transfer. The transfer of required information is periodic, prescheduled, or performed on an as-needed basis.

In some embodiments, the received information includes localization information. Localization information includes but is not limited to time zone conversions, daylight savings time adjustments, currency conversions, language translation, or any other information specifying a mapping between a value in a first representation and that same value in a second representation.

Once local computer 204 has received the information (Step 304), it automatically formats the information, a subset of, or an entry therein into a machine-readable source code file (Step 306). In one embodiment, the subset of required information is localization information, as discussed above. These source code files may be written in a computer language such as Visual Basic, Python, Java, Perl, etc., as known to one of ordinary skill in the art.

Local computer 200 compiles the source code file into a machine-executable binary object (Step 308), such as a common object request broker architecture (CORBA) compliant object, a component-object model (COM) object, a distributed component object model (DCOM) object, or a dynamically-linked library (DLL). Each compiled object includes enough functionality to transform a data value from a first representation to a second representation. In accordance with the present invention, the compiled object may transform multiple first data values simultaneously or perform multiple transformations seriatim on a data value. At least one binary object is created through this process, but typically multiple binary objects are generated. The binary objects are stored on the local computer or provided to the remote computer.

When the creation of binary objects is complete, local computer 204 is ready to receive data communications from other computers (Step 310). These communications typically include one or more data entries. Upon receipt of data entries, local computer 204 typically stores them for later processing. It can also process them immediately. In accordance with the present invention, processing involves the invocation of the compiled binary objects as discussed above to transform the value in a data entry from a first representation to a second representation (Step 312).

In accord with the present invention, the computer may also create directories to organize the conversion information and the source code files. For example, the system may store the files containing localization information in one subdirectory, the source code files in a second subdirectory, and the compiled binary objects in a third subdirectory.

To illustrate the operation of the present invention, and not to limit the scope of the claims, assume that local computer 204 is a server computer at a support center 206 providing technical support services to at least one computer 212 at a remote site 208 through a service network 232. This service network 232permits support personnel at local site 200 to access, configure, or otherwise manipulate remote computer system 212 via a network interface. In some embodiments, computers 204, 212, 220, and 228 each connect to network 232 through their own local point-of-presence (POP). This tends to reduce telecommunications access charges, transforming a long-distance call into a local call. The local POPs connect to the network 232 through firewalls, securing the network against malicious client-side activity.

Each POP includes a POP server that establishes and maintains network connections with individual computer systems. Computer systems 204, 212, 220, and 228 establish connections with the POPs using protocols such as Point-to-Point protocol (PPP) or serial-line Internet Protocol (SLIP). Computer systems 204, 212, 220, and 228 establish the connection either as a call placed to the POP by the computer system or as a call placed by the POP to the computer system. Authentication and security may occur using predefined passwords, shared secrets, or public key infrastructure techniques.

The network 232 typically carries data using electrical signalling, optical signalling, wireless signalling, a combination thereof, or any other signalling method known to the art. The network 232 can be a fixed channel telecommunications link such as a T1, T3, or 56 kb line; LAN or WAN links; a packet-switched network such as TYMNET; a packet-switched network of networks such as the Internet; or any other network configuration known to the art. The network 232 typically carries data in a variety of protocols, including but not limited to: user datagram protocol (UDP), asynchronous transfer mode (ATM), X.25, and transmission control protocol (TCP).

At intermittent and unpredictable intervals, errors occur during the operation of remote computer 212. When an error occurs, remote computer 212 or dedicated functionality therein gathers transactional information concerning the error. This transactional information includes but is not limited to the type of error, an error code, the time the error occurred, and the date the error occurred. In this embodiment, remote computer 212 transmits this transaction information to server computer 204. The server computer 204 may record the local time marking the receipt of the transaction information.

In this embodiment, a system administrator, i.e., a user with system operation privileges, wishes to view one or more data entries previously transmitted to local computer 204. The system administrator operates computer 204 directly or using computer 228 in a second remote location 224. Local site 200 or second remote location 224 differ from remote location 208 in preferred language, local time, preferred currency, etc. Thus, the system administrator viewing the data entries must translate them to address the idiosyncrasies of locations 200, 208 and 224 before the error data can be fully utilized.

This embodiment, automates the translation process by applying compiled binary objects to the data entries, transforming them to values appropriate for viewing by the system administrator. Thus, when the system administrator sends a request for data entries including, for example, a timestamp the local computer 204 receives the request, locates the requested data entries, selects an appropriate binary object, and uses the selected binary object to transform the timestamp from the local time of computer 212 to a time local to the system administrator.

In this embodiment, reference computer 220 is a publicly-accessible computer provided by the National Institutes of Health (NIH), containing time-zone conversion information at ftp://elsie.nci.nih.gov/pub. This conversion information is provided as several zone information files (ZIFs). Before distribution, the ZIFs are combined into a single archive file and then compressed using GNU Zip (gzip). Each ZIF contains conversion information relevant to a particular zone. Zones are defined geographically, including zones for Africa, Antarctica, Asia, Australasia, Europe, PacificNew, and South America. A separate “StandardTime” zone specifies a set of 24 time zones spanning the globe.

ZIFs have a specific file format. Each file is composed of a varying number of lines, with each line including several fields. Fields may be separated by any number of spaces, while leading and trailing spaces are ignored. A “#” character introduces a comment which extends to the end of the line. Any blank line in the ZIF is ignored. There are two varieties of non-blank lines: zone lines and rule lines.

A zone line and its fields takes the following form:

“Zone NAME GMTOFF RULES/SAVE FORMAT [UNTIL]”.

For example, a line could read:

“Zone Australia/Adelaide 9:30 Aus CST Oct. 31, 1971 2:00”. The word “Zone” indicates that the line is a zone line. The “NAME” field is the name of the time zone, here “Australia/Adelaide.” “GMTOFF” describes the time offset between UTC and the local time in the time zone, here 9 hours, 30 minutes. The “GMTOFF” field is prefaced by a minus sign (“−”) when the offset is negative. The “RULES/SAVE” field specifies the name of the rules that apply in the time zone, here “Aus”, as defined in a rule line discussed in greater detail below. When the “RULES/SAVE” field is a dash (“-”), then standard time always applies in the time zone. The “FORMAT” field specifies the format for time zone abbreviations in this time zone, here “CST.”

The optional “UNTIL” field indicates if and when the values of the “GMTOFF” or “RULES” fields must change to comply with local daylight savings time adjustments. The “UNTIL” field specifies a year, month, day, and time of day. Time zone information is computed using the values of the “GMTOFF” and “RULES” fields until the time specified in the “UNTIL” field. Here the “UNTIL” field has the value “Oct. 30, 1971 2:00.” Therefore the values in the “GMTOFF” and “RULES” fields are valid until 2 a.m. on Oct. 30, 1971.

When the “UNTIL” field is utilized, the next line in the ZIF is a continuation line. The continuation line shares the format of the zone line, except that it does not have the keyword “Zone” at the start of the line. The continuation line contains UTC offset and rules values for use after the time specified in the “UNTIL” field of the preceding zone line. Continuation lines may themselves contain “UNTIL” fields, indicating that the GMT offset and rules specified by the continuation are themselves subject to expiration or replacement at a particular point in time. In that case, the next line will be a second continuation line with information for use after the passage of the time in the first continuation line.

A rule line has the form:

“Rule NAME FROM TO TYPE IN ON AT SAVE LETTER/S”

For example, a valid rule line could read:

“Rule US 1967 1973- Apr lastSun 2:00 1:00 D”

The keyword “Rule” indicates that the present line is a rule. The “NAME” field serves to name the set of rules to which the instant rule belongs, here “US.” As discussed above, the “NAME” field provides a convenient facility whereby a set of rules can be associated with a particular zone. Rules named here may be invoked by name later in a zone line.

The “FROM” field specifies the first year in which the rule applies, here “1967.” Conversely, the “TO” field specifies the final year in which the rule is applicable, here “1973.” The “TYPE” field is a nullity and is always assumed to have the value−. The “IN” and “ON” fields respectively specify the month and day on which the given rule takes effect. The “AT” field specifies the time of day when the rule becomes effective. The “SAVE” field specifies the amount of time to be added to local standard time when the rule is in effect. “LETTER/S” specifies the variable part of the time zone abbreviation for use when the rule is in effect.

In this embodiment, server computer 204 downloads the ZIFs and converts them into Microsoft Visual Basic source code, with each time zone having a separate Visual Basic project. The conversion is accomplished using a set of generic Visual Basic template files. The template files specify class definitions for listing objects and conversion objects, the time and date functions, and other information which remains constant among time zones.

The file paths specifying the locations of dynamically-created Visual Basic files are typically stored in a text file accessible to the system. The Visual Basic projects are compiled into binary objects, with compilation errors typically stored in a text file for later review. File path information identifying the location of each compiled binary object is typically stored in a text file accessible to the system. In this embodiment, the binary objects are Visual Basic component object model (COM) dynamically-linkable libraries (DLLs).

The set of compiled binary objects particularly defines a first set of methods for providing the names of the areas and time zones supported by the system. These methods permit a user to see all of the areas and time zones available for conversion or a subset thereof. Using these same methods, a user can provide a time zone value and receive an identifier for a conversion object capable of localizing time values to the provided time zone. This first set of methods can be used to generate GUI elements that a user interacts with to select their present location and time zone.

The first set includes four methods. The first method, GetArrayOfAreas, returns an array of strings containing area names, e.g., Asia. The second method, GetArrayOfZones, returns an array of strings containing time zone names. GetArrayOfZones optionally accepts an area name as a parameter which, when present, only returns the particular time zones in that area. The third method, ToClassName, accepts an area and a time zone as input parameters and returns a value identifying the particular COM object implementing the local-to-UTC conversions for that particular time zone as discussed below. The fourth method, ToClassName2, accepts an area and a zone name as inputs and returns a value identifying the particular COM object implementing the local-to-UTC conversions for that particular zone.

The set of binary objects defines a second set of methods for converting time values between UTC and local time. Each conversion object implements two methods: LocaltoUTC and UTCtoLocal. LocaltoUTC accepts a string value containing a local time and date and returns a string value containing that same time and date in UTC format. Conversely, UTCtoLocal accepts a string value containing a time and date in UTC format and returns a string value containing a local time and date. Both of these methods accept an optional string parameter specifying the format of the returned string value.

Some embodiments also include automated facilities or scripts for the testing of compiled binary objects. In one embodiment addressing the conversion of times between time zones, a script calls both conversion methods for each compiled object, displaying or logging any errors resulting from invocation. A second script invokes both conversion methods for each time zone with 4 different date/time formats, indicating any errors resulting from the attempted conversion. A third script permits the user to select a time zone, provide a date/time input and an optional format string, and then invokes the UTCtoLocal and LocaltoUTC methods using the supplied time value.

Many alterations and modifications may be made by those having ordinary skill in the art without departing from the spirit and scope of the invention. Therefore, it must be expressly understood that the illustrated embodiment has been shown only for the purposes of example and should not be taken as limiting the invention, which is defined by the following claims. The following claims are thus to be read as not only literally including what is set forth by the claims but also to include all equivalent elements for performing substantially the same function in substantially the same way to obtain substantially the same result, even though not identical in other respects to what is shown and described in the above illustrations.

What is claimed is:

1. A method for generating a binary object in a computer system including a local site in communications with a remote site, said method comprising the steps:
(a) receiving information at a local site from a remote site;
(b) transferring said information into a binary object; and
(c) applying said binary object to transform a data value.

2. The method of claim 1 further comprising the step of (d) storing said binary object at said local site.

3. The method of claim 1 wherein said binary object comprises a method for converting a coordinated universal time (UTC) value into a localized time value.

4. The method of claim 3 wherein said method for converting a coordinated universal time (UTC) value into a localized time value comprises the steps:
(a) receiving a coordinated universal time (UTC) value;
(b) converting said UTC value to a localized time value; and
(c) providing said localized time value.

5. The method of claim 1 wherein said binary object includes a method for converting a localized time value into a coordinated universal time (UTC) value.

6. The method of claim 5 wherein said method for converting a localized time value into a coordinated universal time (UTC) value comprises the steps:
(a) receiving a localized time value;
(b) converting said localized time value to a coordinated universal time (UTC) value; and
(c) providing said UTC value.

7. The method of claim 1 wherein step (b) comprises the steps:
(b-a) converting said information into a source code file; and
(b-b) compiling said source code file into a binary object.

8. A method for generating a binary object in a computer system including a local site in communication with a remote site, said method comprising the steps:
(a) receiving information at a local site from a remote site, said information including localization information; and
(b) transferring said localization information into a binary object.

9. The method of claim 8 wherein said localization information comprises at least one of information describing the relationship between coordinated universal time (UTC) and a localized time, and information describing scheduled clock adjustments.

10. The method of claim 8 wherein said binary object comprises a method for converting a coordinated universal time (UTC) value into a localized time value.

11. The method of claim 8 wherein said method for converting a coordinated universal time (UTC) value into a localized time value comprises the steps:
(a) receiving a coordinated universal time (UTC) value;
(b) converting said UTC value to a localized time value; and
(c) providing said localized time value.

12. The method of claim 8 wherein said binary object includes a method for converting a localized time value into a coordinated universal time (UTC) value.

13. The method of claim 12 wherein said method for converting a local time value into a coordinated universal time (UTC) value comprises the steps:
(a) receiving a localized time value;
(b) converting said localized time value to a coordinated universal time (UTC) value; and
(c) providing said coordinated universal time (UTC) value.

14. The method of claim 8 further comprising the step of (c) applying said binary object to information received through a connection between said local site and a remote site.

15. The method of claim 14 wherein said information received through a connection includes a localized time value.

16. The method of claim 8 wherein step (b) comprises the steps:
(b-a) converting said localization information into a source code file; and
(b-b) compiling said source code file into a binary object.

17. The method of claim 16 wherein said source code file is a Visual Basic file.

18. The method of claim 11 wherein said binary object is a component object model (COM) dynamically-linked library (DLL).

19. A system for providing automated localization of data sets, comprising:
a remote site; and
a local site, said local site comprising:
a computer, said computer comprising a binary object, said binary object comprising a method for time conversion; and
a communications module, said communications module providing telecommunications between said remote site and said local site,
wherein said remote site provides a record comprising a data entry comprising a time value to said local site using said communications module.

20. A method for facilitating automated localization of data sets in a computer system including a local site and a remote site, said method comprising the steps:
(a) providing a connection between said local site and said remote site;
(b) receiving information at said local site from said remote site, said information including a first time value;
(c) applying a transformation to said received information, said transformation converting said first time value in said received information into a second time value; and
(d) providing said second time value.
